(19) United States
(12) Patent Application Publication
(10) Pub. No.: US 2023/0157338 A1
(43) Pub. Date: May 25, 2023

(54) ELECTROLYTE-ENHANCED SWEETENER AND CONSUMABLE PRODUCTS OBTAINED

(71) Applicant: Todd EWING, Walnut Creek, CA (US)

(72) Inventor: Todd EWING, Walnut Creek, CA (US)

(21) Appl. No.: 18/094,318

(22) Filed: Jan. 6, 2023

Related U.S. Application Data
(63) Continuation of application No. 16/416,665, filed on May 20, 2019, now abandoned.
(60) Provisional application No. 62/673,977, filed on May 20, 2018.

(51) Int. Cl. A23L 27/30; A23L 2/60; A23L 33/125; A23L 33/16

(52) U.S. Cl. CPC A23L 27/30; A23L 2/60; A23L 33/125; A23L 33/16; A23V 2200/15

(57) ABSTRACT

The present invention relates to compositions and methods that utilize dietary electrolyte salts to improve the flavor of high-potency sweeteners and to enhance the synergistic effects between high-potency sweeteners and carbohydrate sweeteners. Specific dosage levels of dietary potassium and sodium have been discovered that correct the flavor deficits of existing high-potency sweeteners related to off-flavor, after-taste, thin mouth-feel, and loss of sweetness at high doses. In addition, these dosage levels of dietary electrolytes amplify the synergy between high-potency sweeteners and trace quantities of carbohydrate sweeteners. Consequently, electrolyte-enhanced sweetener compositions elicit sweetness, flavor, and mouth-feel profiles nearly indistinguishable from pure sugar. These compositions possess negligible calories and are compatible with a wide range of foods, beverages, serving, and preparation conditions and with food labels related to natural, organic, GMO free, allergen free, and gluten free.

### RELATED APPLICATION DATA

This application is a continuation of U.S. Patent Application No. 16/416,665 filed on May 20, 2019, which claims priority to U.S. Provisional Application No. 62/673,977 filed on May 20, 2018, the entire contents of which are hereby incorporated by reference in their entirety.

### REFERENCES CITED

### U.S. Patent Documents

U.S Pat. No. 5,106,632, April 1992, Wong , et al.

U.S Pat. No. 7,851,005, December 2010, Bingley, et al.

U.S Pat. No. 8,962,698, Feb. 24, 2015, Bridges , et al.

U.S Pat. No. 8,993,027, March 2015, Prakash , et al.

U.S Pat. No. 9,011,956, April 2015, Prakash , et al.

U.S Pat. No. 9,044,038, June 2015, Yoshinaka, et al.

U.S Pat. No. 9,609,887, April 2017, Quinlan, et al.

U.S Pat. No. 9,775,373, Oct. 3, 2017, Hansen , et al.

### Other References

Adlind, et al., Circulation, 39, 685-692 (1969)

Antenucci and Hayes, Nonnutritive sweeteners are not supernormal stimuli, Int J Obes (Lond), 39(2), 254-259 (2015).

Birch, Modulation of sweet taste, Biofactors, 9(1), 73-80 (1999).

Deis, R.C., Sweeteners for Health Foods, Food Product Design: February 2001.

Dvoryanchikov et al., Inward rectifier channel, ROMK, is localized to the apical tips of glial-like cells in mouse taste buds, J Comp Neurol., 517(1), 1-14 (2009).

Dzendolet et al., Gustatory quality changes as a function of solution concentration, Perception & Psychophysics, 2, 29-33 (1967).

Electronic Code of Federal Regulations, Title 21: Food and Drugs, PART 101—FOOD LABELING, Subpart D—Specific Requirements for Nutrient Content Claims, Chapter I, Subchapter B, Part 101, Subpart D, Section 101.60 (2018).

Low et al., Psychophysical Evaluation of Sweetness Functions Across Multiple Sweeteners, Chem Senses, 42(2), 111-120 (2017).

Hodgkin and Huxley, A quantitative description of membrane current and its application to conduction and excitation in nerve, J Physiol., 117(4), 500-544 (1952).

Frequently Asked Questions for Industry on Nutrition Facts Labeling Requirements What are Daily Values and where can I find them?

Kilcast et al., Sweetness of bulk sweeteners in aqueous solution in the presence of salts, Food Chemistry 70(1), 1-8 (2000).

Kolesnikov and Bobkov, Regulation of the conductance and resting potential by extracellular K+in frog taste receptor cells, Membr Cell Biol., 13(2), 321-335 (2000).

Kolesnikov and Margolskee, Extracellular K+activates a K(+)- and H(+)-permeable conductance in frog taste receptor cells, J Physiol. 507 (Pt 2), 415-432 (1998).

Majchrzak et al., Sucrose-replacement by rebaudioside a in a model beverage, J Food Sci Technol, 52(9), 6031-6036 (2015).

Mettler et al., Osmolality and pH of sport and other drinks available in Switzerland Swiss J Sports Med, 54(3):92-95 (2006).

Momtazi-Borojeni et al., A Review on the Pharmacology and Toxicology of Steviol Glycosides Extracted from Stevia rebaudiana, Curr Pharm Des., 23(11), 1616-1622 (2017).

Perrier et al., Circadian variation and responsiveness of hydration biomarkers to changes in daily water intake, Eur J Appl Physiol, 113(8), 2143-2151 (2013).

Philippaert et al., Steviol glycosides enhance pancreatic beta-cell function and taste sensation by potentiation of TRPMS channel activity. Nat Commun., 8, 14733 (2017).

Sawinski et al., Osmolality of Normal Human Saliva at Body Temperature, Clin Chem., 12(8) 513-514 (1966).

Schiffman et al, Investigation of Synergism in Binary Mixtures of Sweeteners, Brain Research Bulletin, 1995, vol. 38, No. 2, pp. 105-120.

Schiffman et al., Synergism among Ternary Mixtures of Fourteen Sweeteners, Chem. Senses 25:131-140, 2000.

White, et al., Physiological and pharmacological regulation of human salivary electrolyte concentrations; with a discussion of electrolyte concentrations of some other exocrine secretions, J Clin Investig., 34(2), 246-255 (1955).

Winther et al., BMC Obes., 27, 4:41 (2017). Intake of non-nutritive sweeteners is associated with an unhealthy lifestyle: a cross-sectional study in subjects with morbid obesity.

Yee et al., Glucose transporters and ATP-gated K+(KATP) metabolic sensors are present in type 1 taste receptor 3 (T1r3)-expressing taste cells, Proc Natl Acad Sci U S A., 108(13), 5431-5436. (2011)

### FIELD OF THE INVENTION

The invention pertains to compositions and methods for utilizing dietary electrolyte salts to enhance the flavor of high-potency sweeteners and to enhance the synergistic flavor effects of high-potency sweeteners with trace quantities of sugar. Electrolyte-enhanced sweetener compositions have greater sweetness intensity, fast sweetness onset, minimal aftertaste, and rich syrupy thickness that produce flavor and mouth-feel nearly indistinguishable from pure sugar. Most importantly, electrolyte-enhanced sweetener compositions possess negligible calories and offer a broad compatibility with the widest range of foods, beverages, temperatures, and acidities, and with food labeling requirements related to natural, organic, non-genetically modified organisms, allergen free, and gluten free. The invention pertains to packaged sweetener compositions produced by these methods. The invention pertains to packaged foods, beverages, edible products, and oral dentifrices sweetened with these sweetener compositions.

### BACKGROUND OF THE INVENTION

The added sugars in foods and beverages are increasingly associated with health risks such as obesity and diabetes and are coming under increasing regulatory scrutiny. Unfortunately, consumers are not satisfied with the alternatives to sugar, such as non-caloric sweeteners. Consumers notice that non-caloric sweeteners tend to taste artificial and lack the rich flavor and intense sweetness of real sugar. The perceived artificial flavor of non-caloric sweeteners arises from a thin mouthfeel, delayed sweetness, lingering aftertaste, and chemical off-flavors. Consequently, there is tremendous public health need for sweeteners that taste thicker and more natural like sugar in order to make a significant reduction in the use of added sugars in foods.

Natural high-potency sweeteners such as stevia and monk fruit have tremendous potential as sugar substitutes because they are as potent as artificial sweeteners and yet sidestep many of the health controversies associated with artificial sweeteners. However, just like artificial sweeteners, natural high-potency sweeteners tend to taste artificial because they also elicit a thin mouth-feel, slow sweetness onset, lingering aftertaste, bitterness, and off-flavors.

In preferred embodiments of this invention, dietary electrolyte salts are added to stevia and monk fruit sweeteners to enhance aspects of sweetness flavor. Their other potential enhancement effects can be attributed to the essential roles of electrolytes in taste cells on the tongue and in the salivary fluids that bring food molecules to the tongue. White, Abraham G., et al., J Clin Investig., 34 (2), 246-255 (1955) show that potassium levels in salivary fluid are higher than any other bodily fluid such as sweat fluid and blood. Kolesnikov and Margolskee, J Physiol. 507 (Pt 2), 415-432 (1998) show that potassium enhances the activity of taste cells in the laboratory. In addition, Dzendolet et al., Perception & Psychophysics, 2, 29-33 (1967) report that plain water with low levels of dissolved potassium and sodium tastes mildly sweet to some people. And, Birch G G, Biofactors, 9(1), 73-80 (1999) report that low levels of dissolved potassium and sodium mildly enhance the perceived sweetness of sugar.

Potassium has been described as a sweetness enhancer in U.S. Pat. No. 5,106,632 which discloses how to improve the sweetness of the high-potency sweetener acesulfame potassium by combining it with potassium chloride and an organic acid. It teaches how the desired quantities of the components should be approximately equal when expressed as a weight percent.

In preferred embodiments of this invention, dietary electrolyte salts are added to stevia and monk fruit sweeteners to enhance the perceived thickness of flavor. A rationale for this strategy is based on the osmotic pressure experienced by taste cells on the tongue. According to Perrier et al., Eur J Appl Physiol, 113(8), 2143-2151 (2013), taste cells are typically exposed to an osmotic pressure of about 80 milliosmoles. According to Mettler et al., Swiss J Sports Med, 54(3)92-95 (2006), sugar-sweetened soft drinks have an osmotic pressure around 500 milliosmoles—about six times higher than the osmotic pressure of saliva, while artificially-sweetened soft drinks have an osmotic pressure around 25 milliosmoles—about three times lower than the osmotic pressure of saliva and likely contributing to their thin and watery taste.

Dietary electrolytes—such as potassium, sodium, and chloride—provide an efficient way to increase osmotic pressure, because they have about ten times greater potency on osmotic pressure per unit mass compared to sucrose. Their greater potency arises from the fact that osmotic pressure of an aqueous solution is a colligative property, which means that osmotic pressure is proportional to the number of dissolved particles in the solution rather than the mass weight of dissolved particles. Since potassium, sodium, and chloride ions are each about 10 times lighter than one molecule of sucrose, these electrolytes can contribute 10 times more dissolved particles to solution per unit mass than sucrose.

U.S. Pat. No. 8,993,027 describes the composition of a table top sweetener that enhances the flavor of a stevia-based sweetener, rebaudioside A, by formulating it with erythritol, a sugar alcohol, and flavorants into sweetener compositions. Rebaudioside A is preferred because it is reported to be one of the least bitter sweeteners in stevia, a sweet herb which contains several other natural sweeteners, such as rebaudioside C, rebaudioside D, rebaudioside E, stevioside, and dulcoside A which are collectively called steviol glycosides. Erythritol is preferred because it acts as a bulking agent in the powdered sweetener composition and acts as an osmotic agent to thicken the mouthfeel of sweetened foods and beverages.

U.S. Pat. No. 8,993,027 makes a generic claim for a sweet-taste improving composition as part of a tabletop sweetener composition with ingredients selected from 22 broad chemical classes spanning thousands of potential ingredients. Inorganic salts are included within the thousands of potential ingredients claimed for the sweet-taste improving composition. Unfortunately, this patent also claims 25 different possible bulking agents to combine with the sweet-taste improving composition ingredients and does not provide guidance on which of the 25 bulking agents works best with which of the thousands of potential ingredients for the sweet-taste improving composition, leading to an unbridled claim of hundreds of thousands of possible combinations of ingredients but with no practical guidance on how to choose which combination actually works best in the tabletop sweetener.

U.S. Pat. Nos. 8,962,698, 9,044,038 and 9,609,887 describe practical methods to improve the flavor of stevia sweeteners. They disclose how to formulate rebaudioside A and other steviol glycosides with a natural sweetener mogroside V which is purified from monk fruit. Mogroside V is reported to be one of the most potent natural sweeteners in monk fruit (also called luo han guo or Siraitia grosvenorii), a sweet fruit which also contains the natural sweeteners mogroside I, II, III, and IV. By themselves, monk fruit sweeteners tend to have a molasses off-flavor, slow sweetness onset, and lingering aftertaste. When formulated with rebaudioside A and other steviol glycosides, monk fruit sweeteners tend to mask the bitterness of the stevia sweeteners and balance the overall flavor.

Despite these recent innovations, such natural non-caloric sweeteners have not yet achieved broad consumer acceptance as alternatives to added sugar in sweetened foods and beverages. Particularly in highly sweetened foods and beverages, such as soft drinks, confections, and syrups, non-caloric sweeteners fail to match the intense sweetness of added sugars. Non-caloric sweeteners also fail to match the thick and syrupy mouth-feel, the rapid sweetness onset and the lack of aftertaste of added sugars. Sweetener compositions that exploit new flavor enhancement strategies such as dietary electrolytes—and that can successfully reproduce the complete flavor profile of sugar—will help satisfy consumer expectations and will help reduce the health risks posed by the added sugars in foods and beverages.

### BRIEF SUMMARY OF THE INVENTION

A deeper understanding of the nature and advantages of the present invention may be achieved by referring to the following summary of preferred embodiments of the invention and to the attached claims. The embodiments described in this patent specification should not be construed as limitations of the invention but as illustrations of the scope of the invention.

A preferred embodiment of the invention is a method of using dietary electrolyte salts to enhance the sugar-like flavor of natural low-calorie sweetener compositions. Preferred embodiments utilize high-potency herbal sweeteners such as stevia and monk fruit and natural high-intensity carbohydrate sweeteners such as sugar and corn syrup. The method of electrolyte-enhanced sweetening involves the selection and optimization of the various ingredients comprising dietary electrolyte salts, high-potency sweeteners, and high-intensity sweeteners to amplify the synergistic flavor interactions among the many components. The method can be used with any kind of high-potency sweetener including natural herbal sweeteners and artificial sweeteners. The method can be used with any kind of high-intensity sweetener including sugar, honey, corn syrup, agave syrup, and fruit juice. The method of electrolyte-enhanced sweetening provides a way to create sweetener compositions with sweetness and flavor profiles nearly indistinguishable from sugar and yet with negligible added sugar per serving and negligible added calories per serving.

Another preferred embodiment of the invention is a packaged sweetener composition produced by the method of electrolyte-enhanced sweetening. The packaged sweetener composition elicits a syrupy flavor and sweetness nearly indistinguishable from natural sugar with a negligible fraction of added sugar and added calories. The packaged sweetener composition can be produced using natural organic ingredients. It can also be produced using artificial and synthetic ingredients. A one-quarter-gram or one-sixteenth-teaspoon serving of this sweetener is equivalent in sweetness and flavor to an eight-gram or two-teaspoon serving of natural sugar. Because of its electrolyte-enhancement, a one-quarter-gram serving provides about 16 milligrams of dietary potassium (0% daily value) and about 3 milligrams of dietary sodium (0% daily value). A preferred embodiment comprises, in descending order by weight, organic cane sugar, organic cane sugar extract, organic stevia leaf extract, potassium chloride, and sea salt.

Another preferred embodiment of the invention is a packaged sweetened beverage composition produced using the method of electrolyte-enhanced sweetening. A preferred embodiment is a 12-ounce serving of carbonated cola beverage containing an electrolyte-enhanced sweetener. Whereas a typical 12-ounce serving of cola contains 36 grams of sugar and 140 calories, a preferred embodiment of this invention would contain 1.5 grams of electrolyte-enhanced sweetener contributing only a single gram of sugar and four calories. Consequently, a preferred embodiment of this invention would elicit a flavor and syrupy sweetness nearly indistinguishable from an equivalent sugar-sweetened cola with a 97% reduction of added sugar and sugar calories. In addition, a 12-ounce serving of an electrolyte-enhanced sweetened cola would also provide around 85 milligrams of additional dietary potassium (2% daily value) and around 15 milligrams of additional dietary sodium (0% daily value) from the sweetener composition alone which could qualify it as a very low sodium beverage.

Another preferred embodiment of the invention is a packaged flavored syrup composition produced using the method of electrolyte-enhanced sweetening. A one-quarter-cup serving of the flavored syrup composition provides the same syrupy flavor and sweetness profile as a one-quarter cup serving of regular tabletop syrup yet contains about 12 grams of added sugar instead of 60 grams of added sugar and about 48 calories instead of 240 calories, representing an 80% reduction in added sugar and calories. Each serving contains sufficiently reduced sugar and calorie content that it qualifies for a “Reduced sugar” as well as a “Naturally Sweetened” marketing claim on the label. Each serving also contains an additional 105 milligrams or 3% daily value of dietary potassium and 20 milligrams or 0% daily value of dietary sodium arising from the electrolyte-enhanced sweetener.

Other preferred embodiments of the invention include packaged coffees, teas, juices, sparkling juices, canned fruits, jams, yogurts, frozen confections, and ice creams produced by the method of electrolyte-enhancement of high-potency sweeteners with the resulting flavors and syrupy sweetness nearly indistinguishable from their sugar-sweetened product equivalents with a reduction of 75% to 98% of the typical added sugar calories.

Foods and beverages can be sweetened with compositions that embody this invention and can meet the strict criteria for negligible calorie content set by the U.S. Food and Drug Administration which is five calories or less per serving according to the Electronic Code of Federal Regulations, Title 21, Chapter I, Subchapter B, Part 101, Subpart D, Section 101.60 (2018). Therefore, such foods and beverages can have 95% of the flavor of sugar-sweetening and yet can be labeled as “calorie free,” “free of calories,” “no calories,” “zero calories,” “without calories,” “trivial source of calories,” “negligible source of calories,” or “dietarily insignificant source of calories”.

In addition, foods and beverages can be sweetened with compositions that embody this invention and can also meet the strict criteria for negligible sugar content set by the U.S. Food and Drug Administration which is less than 0.5 grams of sugar per serving according to the same Electronic Code of Federal Regulations above. Therefore, such foods and beverages can have 95% of the flavor of sugar-sweetening and yet can be labeled as “sugar free,” “free of sugar,” “no sugar,” “zero sugar,” “without sugar,” “sugarless,” “trivial source of sugar,” “negligible source of sugar,” or “dietarily insignificant source of sugar.”

### DETAILED DESCRIPTION OF THE INVENTION

The invention pertains to electrolyte-enhanced sweetener compositions and their methods of preparation. Dietary electrolyte salt compositions have been discovered that enhance high-potency sweeteners such as stevia leaf extract and monk fruit extract by correcting multiple flavor deficits of these natural sweeteners that have heretofore hindered their widespread adoption as sugar substitutes. Typically, stevia and monk fruit sweeteners have suffered from off-flavors, delayed sweetness taste, lingering aftertaste, thin mouth-feel, and a limited sweetness intensity. Electrolyte-enhancement corrects these deficits and creates natural sweeteners with flavors and mouth-feel nearly indistinguishable from natural sugar. Electrolyte-enhanced sweetener compositions possess negligible calories, offer a broad compatibility with the widest range of foods, beverages, temperatures, and acidities. Electrolyte-enhanced sweetener compositions can comprise natural and organic ingredients.

The dietary electrolytes contained in the compositions discovered in this invention appear to modulate the electrophysiological activities of taste cells. The dietary electrolytes comprise potassium, sodium, and chloride which naturally exist in the mouth. These dietary electrolytes are used by taste cells to generate action potentials within the cell, leading to chemical signals released to neighboring nerve cells that, in turn, generate action potentials within nerve cells to ultimately transmit taste perception to the brain. These dietary electrolytes are known to interact directly with ion channels, transporters, and receptors in the membranes of taste cells. These dietary electrolytes provide a reservoir of support for the flow of electrolytes across the taste cell membranes. When combined with high-potency sweeteners, these dietary electrolytes improve deficits in sweetness intensity, the speed of sweetness onset, and the speed of sweetness decay. The electrolytes also enhance the perceived sugar-like thickness and syrupy texture elicited by the sweeteners by direct osmotic effects on taste cells. The electrolytes provide a generalizable strategy to correct the deficits of high-potency sweeteners and to increase their synergistic effects with high-intensity carbohydrate sweeteners containing sugars and sugar alcohols.

The invention pertains to packaged sweetener compositions produced by these methods. The invention also pertains to packaged food products, packaged beverage products, chewing gum products, and oral care products sweetened by sweetener compositions produced by these methods. Embodiments of this invention can use natural and organic ingredients as electrolyte compositions, high-potency sweetener compositions, and high-intensity carbohydrate sweetener compositions. For most food, beverage, chewing gum, oral care, and sweetener compositions that embody this invention, the carbohydrate compositions require such small quantities of sugar that calories tend to be negligible. For the most intensely sweetened embodiments of this invention, such as syrups and confections, the calories become significant, but remain a small fraction of the calories found in equivalent sugar-sweetened products.

### A. The Definition of Sugar-Like Flavor

The compositions and methods that embody this invention describe how to form electrolyte-enhanced sweetener compositions that better reproduce the flavor of natural sugar with negligible calories and with favorable physical properties. According to these methods, sugar-like flavor was defined by the numerical consensus of four criteria which were sugar-like taste, intensity, thickness, and compatibility and will be described below.

The four criteria were quantified numerically as four percentile scores. Scores of 100% represented the complete and satisfying reproduction of each criterion of sugar-like flavor. For reference, naturally-refined cane sugar received percentile scores of 100% across all criteria because of how the criteria were defined.

Taste (TAS) The criterion of sugar-like taste encompasses how well a sweetener reproduces the taste of sugar at a high level of sweetness corresponding to a 10% sucrose solution. Ten percent sucrose is equivalent to a 12-ounce soft drink (355 milliliters) sweetened with 36 grams of sucrose. For reference, the sweet taste of sugar develops and recedes across the entire tongue with each tasting in a characteristic way. The time profile of sugar's sweetness is something we generally take for granted until we taste a sweetener with a different time profile that makes it taste unnatural and unsatisfying.

For a sweetener to taste like sugar, its sweetness must be detected according to the same time and location profile as sugar. Sweetness must be detected instantly across the entire tongue, otherwise it will unnaturally draw attention to some other location, such as the front of the tongue or the back of the throat. Sweetness must reach a maximum intensity within milliseconds, otherwise it will seem to have an unnaturally delayed sweetness. Sweetness must decay within seconds, or it will seem to have a lingering aftertaste. With subsequent tasting, sweetness should gradually fade. It should not fade too quickly or slowly or strengthen unnaturally with subsequent tastings.

According to a preferred embodiment of this invention, the tastes of sweetener compositions (TAS) were compared to 10% sucrose and evaluated based on the following taste and olfactory flavor properties:
1. Sweetness across the entire tongue and not in throat;
2. Rapid onset of sweetness without delay;
3. Rapid decay of sweetness without lingering after-taste;
4. Sweetness without bitterness;
5. Subtle caramel flavor without off-flavors.

Intensity (INT) The criterion of sugar-like intensity represents how well a sweetener reproduces the same five taste properties of sugar (represented by TAS) but at a very high level of sweetness typical in desserts. Drinking water sweetened with 20% sucrose is used as a taste reference for evaluating INT.

Intensity remains an important and unmet criterion for high-potency sweeteners, such as rebaudioside A, cyclamate, sucralose, and aspartame, as described in Antenucci and Hayes, Int J Obes (Lond), 39(2), 254-259 (2015) and Low et al., Chem Senses, 42(2), 111-120 (2017). High-potency sweeteners elicit mild sweetness at doses smaller than sugar because they are more potent, but these sweeteners fail to elicit intense sweetness at high doses like sugar can. High-potency sweeteners tend to elicit bitterness and other off-flavors at high doses that interferes with their abilities to elicit pure sweetness. Reproducing a high sugar-like intensity of sweetness at high doses is an important design goal of this invention.

Thickness (THK) The criterion of sugar-like thickness represents how well a sweetener reproduces the thick texture of sugar-sweetening that becomes syrupy at higher dose levels. Drinking water samples sweetened with 10% sucrose and with 20% sucrose are used as taste references for evaluating THK.

Compatibility (CMP) The criterion of sugar-like compatibility represents how well a sweetener can sweeten the widest range of foods and beverages without disturbing the most delicate food flavors. It also represents how consistently it elicits a sugar-like flavor in beverages at low and high temperatures. Hot-brewed tea and cold-brewed coffee sweetened with 10% sucrose were used as taste references for evaluating CMP.

Total (TOT) The consensus of the percentile scores for the four criteria was determined by numerical averaging to form a total score of sugar-like flavor.

### A1. Methods to Judge Sugar-Like Flavor

The first three criteria for sugar-like flavor—taste TAS, intensity INT, and thickness THK—were evaluated by taste judges who compared water sweetened to a level of either 10% or 20% sucrose to water sweetened with various sweetener compositions. A level of 10% sucrose represents the sweetness of typical soft drinks and 20% sucrose represents the sweetness of typical desserts.

Taste judges initially evaluated the sugar-like taste TAS and thickness THK of sweetener compositions at the sweetness level of typical soft drinks. They rinsed their mouths with plain water and then evaluated a 100 mL sample of 10% sucrose solution. They took a 15 mL aliquot of the sample into the mouth and swished it around for about 15 seconds. For each mouthful, they evaluated the time course of sweetness onset and decay, natural sugar flavors, off-flavors, and thickness, and they expelled the aliquot into a waste receptacle. Judges continued taking a series of mouthfuls up to a total volume of 100 mL to evaluate the changes in flavor perception from one mouthful to the next related to the natural loss of perceived sweetness, flavor, and thickness of sugar solutions. This protocol was then repeated for each 100 mL sample of spring water sweetened with various sweetener compositions.

Taste judges repeated the evaluation with a second round of taste testing at a higher sweetness level to assess sugar-like intensity INT and thickness THK for the most promising sweetener compositions. Samples were made by dissolving the same quantities of sweeteners into half the volume, 50 mL, of spring water and were compared to a solution of 20% sucrose which represents the sweetness of desserts and confections. Taste judges again evaluated for each mouthful the time course of sweetness onset and decay, natural sugar flavors, off-flavors, and thickness. Taste testing at this higher level of sweetness typically poses a challenge for high-potency sweeteners which easily exceed the potency of sugar at lower sweetness levels and yet fail to match the intensity of sugar at higher sweetness levels.

### A2. Methods to Judge Sugar-Like Compatibility

The criterion for sugar-like compatibility CMP was evaluated separately from the other three criteria because it represents the extent to which sweetener compositions match the broad compatibility of sugar as a sweetener with various foods, food flavors, and food preparation conditions. Compatibility was evaluated by taste judges who assessed the flavors of cold-brewed coffee and hot-brewed tea which were sweetened with either sucrose or various sweetener compositions. The compatibilities of the sweetener compositions were rated as high when the flavors present in the sugar-sweetened beverages were preserved and when the level of sweetness was preserved.

Cold-brewed coffee and hot-brewed tea provide several important tests for sugar-like compatibility. First, these beverages provide a literal acid test for sweetener compositions because their delicate flavors are easily disturbed by acids and anti-acids present in sweetener compositions. Second, these beverages provide a heat test for sweetener compositions because various sweeteners can lose sweetness at either high or low temperatures.

Before testing sweetener compositions, taste judges used the following protocol to establish a frame of reference for their analysis of flavor. They rinsed their mouths with plain water and then evaluated 100 mL samples of cold-brewed coffee and hot-brewed tea that had been sweetened to the level of 10% sucrose.

Tasting judges then rinsed their mouths with plain water and evaluated 100 mL samples of cold-brewed coffee and hot-brewed tea sweetened with various sweetener compositions. To assess sugar-like compatibility CMP, tasting judges evaluated whether the flavors of the sweetened beverages remained the same regardless of whether they were sweetened with sugar or the sweetener compositions.

### A3. Methods to Select and Optimize Ingredients

Those skilled in the art appreciate that the optimization of sweetener compositions is a non-trivial task that requires the adjustment of many ingredients and their proportions. The task can be represented mathematically as an optimization of a system with many variables. Such systems of variables can be optimized efficiently using algorithmic techniques such as divide-and-conquer. The sweetener compositions in this invention were optimized using the divide-and-conquer technique by first optimizing the high-potency sweetener composition, by next adding the carbohydrate composition and optimizing it, and by last adding the electrolyte composition and optimizing it.

### B. The Electrolyte Composition

The center of this invention was the discovery that an electrolyte composition comprising potassium chloride and sodium chloride enhanced the flavor of stevia and monk fruit sweeteners in multiple and unexpected ways. The electrolyte composition was originally developed to address the watery thinness of these sweeteners. When electrolytes were combined with stevia and monk fruit to provide a thicker taste, it was also discovered that they also enhanced the intensity of sweetness and the temporal profile of sweetness onset and decay which all help contribute to a more sugar-like flavor.

The electrolyte-enhanced sweetener compositions that embody this invention are designed to reproduce the thick syrupy mouth-feel of sugary foods and beverages in a way that low-calorie sweeteners have not yet accomplished. For example, sugary sodas have a syrupy thickness that arises from the large quantities of dissolved sugar solids whereas diet sodas have a watery thinness that arises from the minute quantities of dissolved low-calorie sweeteners solids. Low-calorie sweeteners are typically more potent than sugar by a hundred-fold which means that foods and beverages sweetened with them have a discrepancy of dissolved sweetener solids by a hundred-fold. To illustrate the difference, cans of sugar soda tend to sink in ice-water while cans of diet soda tend to float.

The discrepancy of dissolved solids in diet sodas causes a discrepancy in the osmotic pressure experienced by the taste cells on the tongue. Taste cells are accustomed to a background level of osmotic pressure from saliva which contains physiological levels of electrolytes and proteins. The salivary osmotic pressure varies from 55 to 110 milliosmolals and averages around 80 milliosmolals. With sugar-sweetened sodas, the osmotic pressure increases up to 450 milliosmolals—a five-fold increase above average background levels of 80 milliosmolals. On the other hand, with diet sodas, the osmotic pressure drops down to 25 milliosmolals—a three-fold drop below average background levels. The discrepancy in osmotic pressure arising from low-calorie sweeteners contributes to the perceived sweetness being thin and watery.

### B1. Methods to Select Electrolyte Salts

In a preferred embodiment of the invention, the electrolyte candidates for the electrolyte compositions are selected from the known collection of physiological electrolytes that already exist in the mouth and body. This collection includes four positively-charged electrolytes—potassium, sodium, calcium, and magnesium—and four negatively-charged electrolytes—chloride, bicarbonate, lactate, and phosphate.

The electrolytes were acquired as edible, food-grade salts from commercial vendors. The electrolyte salts considered for the embodiments of this invention were calcium carbonate, calcium chloride, calcium lactate, magnesium chloride, magnesium citrate, magnesium sulfate, potassium chloride, sodium bicarbonate, sodium chloride, and sodium phosphate monobasic. This initial set of ten electrolyte salts was evaluated by a sequence of four salt screens in order to identify which salts that had the broadest utility in sweetener compositions.

The first salt screen that was employed tested whether each electrolyte salt had sufficient water solubility. The screen tested whether each salt could dissolve sufficiently into cool drinking water and elicit a thick and heavy flavor without the need for lengthy stirring or heating. The first salt screen generated the following results:

### Salt Screen #1. Does the Electrolyte Salt Have Suitable Solubility?

Calcium Carbonate—Yes

Calcium Chloride—Yes

Calcium Lactate—Yes

Magnesium Chloride—Yes

Magnesium Citrate—NO, Difficult to dissolve

Magnesium Sulfate—Yes

Potassium Chloride—Yes

Sodium Bicarbonate—Yes

Sodium Chloride—Yes

Sodium Phosphate Monobasic—Yes

Nine salts passed this solubility screen, while magnesium citrate failed it. Magnesium citrate was unable to dissolve into plain water, though it is reported to be soluble in acidic solutions. The insolubility of magnesium citrate caused unpleasant cloudiness in the solution and settling on the bottom of the container. Its insolubility also contributed to a chalky flavor.

The second salt screen that was employed tested whether each electrolyte salt could elicit a thick and heavy flavor before it elicited an unpleasant off-flavor, such as saltiness, bitterness, or chalkiness. This screen was only applied to the nine electrolyte salts that passed the first screen. The second salt screen generated the following results:

### Salt Screen #2. Does the Electrolyte Salt Have Suitable Taste (TAS)?

Calcium Carbonate—NO, Develops chalky and dry flavor

Calcium Chloride—Yes

Calcium Lactate—Yes

Magnesium Chloride—Yes

Magnesium Sulfate—NO, Develops sour and dry flavor

Potassium Chloride—Yes

Sodium Bicarbonate—Yes

Sodium Chloride—Yes

Sodium Phosphate Monobasic—Yes

Seven salts passed this taste screen, and two salts failed it. Calcium carbonate tasted chalky while magnesium sulfate tasted sour before either salt could begin eliciting a sugar-like thickness. In addition, both calcium carbonate and magnesium sulfate had an unpleasant drying effect on the tongue.

The third salt screen that was employed tested whether each electrolyte salt could enhance the flavor of sweetener compositions and remain shelf stable when exposed to ambient air. This screen is related to the water solubility of the salt. When salts have too much water solubility, they can become hygroscopic which means they absorb water from ambient air. Hygroscopic salts become wet and clumpy when exposed to ambient air, and they cause sweetener compositions containing them to become difficult to package and dispense because of this instability to air exposure.

This third salt screen is complementary to the first salt screen because it identifies salts with too much water solubility, while the first salt screen identifies salts with too little water solubility. This third salt screen was only applied to the seven electrolyte salts that passed the first and second screens. The third salt screen generated the following results:

Salt Screen #3. Does the Electrolyte Salt have Suitable Shelf Stability?

Calcium Chloride—NO, Develops clumps and stickiness

Calcium Lactate—Yes

Magnesium Chloride—NO, Develops clumps and stickiness

Potassium Chloride—Yes

Sodium Bicarbonate—Yes

Sodium Chloride—Yes

Sodium Phosphate Monobasic—Yes

Five salts passed this stability screen, and two salts failed it. Calcium chloride and magnesium chloride failed this screen because they were strongly hygroscopic, and they caused sweetener compositions to become progressively clumpy, sticky, and gooey within a week of regular use from exposure to ambient air.

The fourth salt screen that was employed tested whether each electrolyte salt could enhance the sweetener compositions used to sweeten cold-brewed coffee and tea without disturbing the flavors of these pH-sensitive beverages. The disturbance of pH-sensitive flavors is an important screen because many electrolyte salts influence the pH of the beverages to which they are added. This screen was only applied to the five electrolyte salts that passed the three earlier salt screens. The fourth salt screen generated the following results:

Salt Screen #4. Does the Electrolyte Salt have Suitable Compatibility (CMP)?

Calcium Lactate—NO, Develops sour/chalky flavor

Potassium Chloride—Yes

Sodium Bicarbonate—NO, Develops sour/chalky flavor.

Sodium Chloride—Yes

Sodium Phosphate Monobasic—NO, Develops sour/chalky flavor

Two salts passed the screen for compatibility, and three salts failed it. Potassium chloride and sodium chloride passed it because they were able to enhance the sweetening of cold-brewed coffee and tea without disturbing the pH-sensitive flavors during brewing. On the other hand, calcium lactate, sodium carbonate, and sodium phosphate monobasic caused the flavor of these beverages to become sour and chalky before they were able to sufficiently enhance sweetening.

In summary, ten food-grade electrolyte salts were evaluated by a sequence of four salt screenings. Only two electrolytes survived all four salt screenings in the sequence.

Salt Screen Summary. Does the Electrolyte Salt Pass All Salt Screens?

Potassium Chloride—Yes

Sodium Chloride—Yes

Calcium Chloride—NO, Develops clumps and stickiness

Calcium Carbonate—NO, Develops chalky and dry flavor

Calcium Lactate—NO, Develops muddy flavor

Magnesium Chloride—NO, Develops clumps and stickiness

Magnesium Citrate—NO, Difficult to dissolve

Magnesium Sulfate—NO, Develops sour and dry flavor

Sodium Bicarbonate—NO, Develops muddy flavor.

Sodium Phosphate Monobasic—NO, Develops muddy flavor

The salt screen identified potassium chloride and sodium chloride as the most promising of the readily available food-grade electrolyte salts. These two salts have the potential evoke a sugar-like thickness in sweetener compositions with suitable solubility, taste, stability, and compatibility with delicate acidity-sensitive beverages.

### B2. Methods to Optimize Electrolyte Composition

Next, the electrolyte composition was optimized by determining the dose-response curve for how each electrolyte salt enhances the sugar-like flavor of the sweetener composition. In a preferred embodiment of the invention, the electrolyte dose levels are optimized after the high-potency sweetener composition has been selected.

For each electrolyte salt, the maximum dose level to test for the dose-response curve was tentatively selected based on reported electrolyte levels in the mouth. It is presumed that electrolyte levels below salivary levels will support taste cell electrochemical activity without eliciting a salty taste. In salivary fluid, the average level of potassium is 800 grams per liter, and the average level of sodium is 600 grams per liter, as reported by White, et al., J Clin Investig., 34(2), 246-255 (1955). These maximum dose levels were tested individually in water that was simultaneously sweetened to be equivalently sweet to a 10% sucrose solution with 1300 mg/L of the high-potency sweetener composition (labelled HPS).

Potassium chloride was evaluated first. It was mixed into HPS sweetened water to achieve a dietary potassium level of 800 grams per liter to match salivary levels. The HPS and potassium mixture tasted thick and mildly bitter but still sufficiently sugar-like, so this dose level was deemed acceptable as an upper limit for testing potassium because any higher dose level would be unnecessarily bitter and degrade the sugar-like flavor. The dose of potassium chloride was then reduced by factors of two by serial dilution with HPS sweetened water containing no electrolytes. Each dilution was tested by taste judges for how well it reproduced the flavor of a 10% sucrose solution with the following results:

### Doses of HPS+Dietary Potassium and Sugar-Like Flavor

1300 mg/L HPS+800 mg/L Potassium: 65% Sugar-Like Flavor

1300 mg/L HPS+400 mg/L Potassium: 70% Sugar-Like Flavor

1300 mg/L HPS+200 mg/L Potassium: 75% Sugar-Like Flavor

1300 mg/L HPS+100 mg/L Potassium: 72% Sugar-Like Flavor

1300 mg/L HPS+0 mg/L Potassium: 65% Sugar-Like Flavor

Based on these results, the optimal level of dietary potassium was 200 mg/L. At this level, the potassium enhanced the sugar-like flavor to about 75% from a starting value of about 65% at zero mg/L, an improvement in sugar-like flavor of about 10%.

The improvement in flavor can be better understood by examining the four criteria of sugar-like flavor assessed by taste judges. As described above in the section titled Methods to Judge Sugar-Like Flavor, these criteria utilize 10% sucrose, 20% sucrose, and hot and cold-brewed coffee to assess them and are assigned as follows:

### Four Criteria of Sugar-Like Flavor

1300 mg/L HPS+0 mg/L Potassium
75% (TAS)+70% (INT) +40% (THK)+75% (CMP)=>65% (TOT)

1300 mg/L HPS+200 mg/L Potassium
80% (TAS)+75% (INT)+70% (THK)+75% (CMP)=>75% (TOT)

At 200 mg/L potassium, the thickness (THK) of the sweetener composition improved the most. In a surprise development, the taste (TAS) and intensity (INT) also improved because the delayed sweetness and prolonged aftertaste of the sweetener became less noticeable, indicating that the potassium appeared to improve the time profile of sweetness onset and decay.

The next step was to evaluate the dose-response curve of dietary sodium while maintaining constant levels of high-potency sweetener and dietary potassium. Sodium chloride was mixed into sweetened (HPS 1300 mg/L) and potassium-enhanced (200 mg/L) water to achieve a sodium level of 600 mg/L to match salivary levels. Unfortunately, this level of sodium tasted unacceptably salty, so the dose level was decreased. At a dietary sodium level of 150 grams per liter, the sweetened (HPS 1300 mg/L) and potassium-enriched (200 mg/L) water tasted thick and only mildly salty, so this dose of sodium chloride was deemed acceptable as an upper limit for testing sodium. The dose of sodium chloride was then reduced by factors of two by serial dilution with sweetened (HPS 1300 mg/L) and potassium-enriched (200 mg/L) water so that only the levels of sodium experienced dilution. Each dilution was tested by taste judges for how well it reproduced the flavor of a 10% sucrose solution with the following results:

### Doses of Dietary Sodium and Enhancement of Sugar-Like Flavor

1300 mg/L HPS+200 mg/L Potassium+150 mg/L Sodium: 75% Sugar-Like Flavor

1300 mg/L HPS+200 mg/L Potassium+75 mg/L Sodium: 78% Sugar-Like Flavor

1300 mg/L HPS+200 mg/L Potassium+40 mg/L Sodium: 80% Sugar-Like Flavor

1300 mg/L HPS+200 mg/L Potassium+20 mg/L Sodium: 79% Sugar-Like Flavor

1300 mg/L HPS+200 mg/L Potassium+0 mg/L Sodium: 75% Sugar-Like Flavor

Based on these results, the optimum level of dietary sodium was 40 mg/L. At this level, the overall solution was noticeably sweeter than before, suggesting that a synergy was discovered between the electrolytes and the high-potency sweetener. The additional sweetness caused the composition to taste sweeter than the 10% sucrose solution, suggesting that the dose level of the HPS should be decreased slightly. It was determined that a decrease in the dose level 1300 mg/L HPS down to 1200 mg/L of HPS was sufficient to recalibrate the sweetness to make it again equivalent to 10% sucrose.

It was noteworthy that the need to reduce the HPS dose because of synergies in the composition occurred in every step of optimizing the compositions that embody this invention. As discussed below, when optimizing the high-potency sweetener composition, synergies between the pair of sweeteners necessitated a dose reduction from 1400 mg/L down to 1300 mg/L. And, as discussed below, when optimizing the carbohydrate composition, synergies between the carbohydrate pair, the electrolyte pair, and the high-potency sweetener pair caused the greatest increase in sweetness and the greatest need for dose reduction of the HPS composition from 1200 mg/L down to 800 mg/L.

The 40 mg/L sodium dose level enhanced the sugar-like flavor to about 80% from a starting value of about 75% at zero mg/L, an improvement in sugar-like flavor of about 5%. This level of improvement was not as great as the improvement from potassium alone, but it was significant and reproducible. Altogether, the optimal doses potassium and sodium enhance the sugar-like flavor to about 80% from a starting value of about 65% at zero mg/L, an improvement in sugar-like flavor of about 15%.

The improvement in flavor can be better understood by examining the four criteria of sugar-like flavor assessed by taste judges. As described above in the section titled Methods to Judge Sugar-Like Flavor, these criteria utilize 10% sucrose, 20% sucrose, and hot and cold-brewed coffee to assess them and are assigned as follows:

### Four Criteria of Sugar-Like Flavor

1300 mg/L HPS+200 mg/L Potassium and 0 mg/L Sodium
80% (TAS)+75% (INT)+70% (THK)+75% (CMP)=>75% (TOT)

1300 mg/L HPS +200 mg/L Potassium and 40 mg/L Sodium
85% (TAS)+80% (INT)+80% (THK)+75% (CMP)=>80% (TOT)

At 200 mg/L potassium and 40 mg/L sodium, the electrolyte composition was discovered to synergize with the high-potency sweetener in several ways. The sweetness increased (TAS) as discussed above which necessitated a slight reduction in the dose level of the HPS composition from 1300 mg/L down to 1200 mg/L. Surprisingly, the time profile of sweetness improved with a faster onset and decay which eliminated the delayed sweetness and aftertaste to the point that the time profile of sweetness tasted as natural as sugar. The intensity (INT) of sweetness increased so that less sweetener was needed to reproduce 20% sucrose. The thickness (THK) also increased as hoped.

These particular doses levels of potassium (200 mg/L) and sodium (40 mg/L) can be related to each other as a weight ratio of about 5:1, which would be evident on food labels of products incorporating this sweetener composition since the quantities of these dietary electrolytes are listed on the Nutrition Facts label. These particular dose levels can also be related to each other as a weight ratio of their salts, potassium chloride to sodium chloride, with a ratio of about 4:1 which could be inspected qualitatively by the ordering of ingredients on the package label. These two ratios differ slightly because of the added weight of the chloride electrolyte.

These particular dose levels of potassium (200 mg/L) and sodium (40 mg/L) can be understood better when they are compared to the dose levels of sugar (100 g/L) in the 10% sucrose solution used as a reference. If we presume that the sweetness arising from sugar and from the electrolyte-enhanced sweetener are sufficiently dose proportional, then for each gram of sugar sweetness in the reference solution, the electrolyte-enhanced sweetener in a preferred embodiment of the invention should contain about two mg/L potassium and about 0.4 mg/L sodium.

For example, a 12-ounce sugar-sweetened soft drink contains 40 grams of sugar. In a preferred embodiment of this invention, an equivalently sweetened and electrolyte-enhanced 12-ounce soft drink would contain at least 80 mg of potassium arising from the sweetener portion of the ingredients which corresponds to two percent of the daily value on the Nutrition Facts label. The 12-ounce soft drink would also contain at least 16 mg of sodium arising from the sweetener which corresponds to zero percent of the daily value.

Quite surprisingly, a preferred embodiment of the invention, the 12-ounce serving of electrolyte-enhanced sweetened soft drink, meets the U.S. Food and Drug Administration's criteria for a very low sodium food which is 35 mg of sodium per serving or less. Such a designation for embodiments of this invention would be unique compared to typical electrolyte-enriched foods and beverages. The electrolyte composition of a typical 12-ounce serving of a sports drink, such as Gatorade, would contain 40 mg of potassium and 150 mg of sodium

The electrolyte compositions selected by the methods that embody this patent are significantly different from other electrolyte compositions, such as those found in sports drinks, energy drinks, water enhancers, nutritional supplements, nutritional beverages, rehydration beverages, and intravenous therapies. Other electrolyte compositions tend to contain more sodium than potassium because they are designed to support the body's overall electrolyte composition in which the levels of sodium greatly exceed potassium. For instance, in sweat fluids the weight content of sodium exceeds potassium by four-fold, and in the bloodstream, the weight content of sodium exceeds potassium by twenty-fold.

Electrolytes not only enhance osmotic pressure, they also enhance the electrochemical activity in taste cells on the tongue and, in turn, they enhance the perception of sweetness and flavor. In sports and energy drinks, electrolytes are used to enhance muscle performance and recovery, but, for the embodiments of this invention, the electrolytes are used to enhance taste cell performance and recovery. Consequently, new methods had to be invented for how the electrolytes are selected, formulated, and dosed.

In contrast, the electrolyte compositions selected by the methods that embody this patent contain more potassium than sodium by factors of about three-fold to five-fold. This unusual potassium-enriched electrolyte balance has been discovered to better enhance the sugar-like flavor of the sweetener compositions. Hypothetically, this discovery could be related to the fact that the salivary fluids in the mouth contain far more potassium than would be expected based on other body fluids because the weight content of potassium in saliva actually exceeds sodium by 33%. And hypothetically, saliva may contain more potassium because potassium may generally enhance the flavor perception ability of the taste cells in the mouth, which would contribute to our survival, because the detection of food flavors by taste cells helps us distinguish safe foods from dangerous foods.

These dose levels of potassium and sodium in preferred embodiments of this invention are novel and unique. Since most U.S. consumers consume too much sodium and not enough potassium, sweeteners and sweetened foods and beverages based on this invention will help shift the balance of potassium and sodium in consumer's diets toward a healthier ratio of potassium to sodium.

Unlike sugar-sweetened foods and beverages, which become unhealthier as they include more sugar sweetening, the embodiments of this invention actually become healthier as they include more electrolyte-enhanced sweetening. For example, a sugar-sweetened product that normally contain 200 grams of sugar could be sweetened with an electrolyte-enhanced sweetener and contain 400 mg potassium and 80 mg sodium, which meets the U.S. Food and Drug Administration's criteria for the “Good source of potassium” health claim on food packaging. To make this health claim, the food or beverage serving must contain 350 mg or more potassium, 140 mg or less sodium, 3 g or less of total fat, 1 g or less of saturated fatty acids, 20 mg or less of cholesterol, and not more than 15 percent of calories from saturated fatty acids.

The surprising sweetness enhancement by potassium and sodium can be rationalized by how these electrolytes support the electrochemical activity of taste cells. The taste cells on the tongue behave much like neurons and heart muscle cells in the way they generate action potentials—an electrochemical current—in response to taste receptor stimulation. When at rest, taste cells build up a charge by pumping sodium and potassium ions across their cell membranes. When they detect sweetness, taste cells discharge the built-up charge by releasing the built-up reservoirs of sodium and potassium ions.

Action potentials and were first described by the Nobel Prize-winning work of Hodgkin and Huxley, J Physiol., 117(4), 500-544 (1952). Action potentials start at the end of taste cells in contact with food, travel down the length of the cells, and terminate at the end in contact with nerve cells. Action potentials are sustained by the actions of cell surface ion channels. Action potentials terminate with the release of chemical transmitters into the synapse-like junction that convey taste signals to adjacent neurons. The chemical signals at the junction must also terminate by the reuptake and recycling of the chemical transmitters from the junction.

### C. The High-Potency Sweetener Composition

Those skilled in the art know that stevia- and monk fruit-based sweeteners are among the most promising natural high-potency sweeteners currently available and that, in general, the taste of high-potency sweeteners can often be enhanced by pairing them together. U.S. Pat. Nos. 8,962,698, 9,044,038 and 9,609,887 were cited previously for their disclosure of sweetener compositions comprising blends of various purified rebaudioside sweeteners from stevia with purified mogroside V sweetener from monk fruit. These two sweeteners happen to have significantly different flavor characteristics that tend to complement each other.

### C1. Methods to Select High-Potency Sweeteners

In a preferred embodiment of this invention, a method to optimize the high-potency sweetener composition is used that exploits the synergism and antagonism between any pairing of high-potency sweeteners including the pairing of stevia and monk fruit extracts. Samples of stevia and monk fruit extracts from many different commercial sources were acquired for a total of eight stevia samples and three monk fruit samples. Each commercial sample was dissolved into one liter of pure water at a dose that most closely matched the sweetness of 10% sucrose, based on iterative rounds of mixing and tasting. The commercial sample which best reproduced the flavor of sugar was selected for each type of sweetener extract.

### C2. Methods to Optimize High-Potency Sweetener Composition

In this example of the method, the best-tasting stevia extract was selected. It was dissolved into water to be equivalently sweet to a 10% sucrose solution which required a dose level of 1400 mg/L, and it was labelled S1. The best-tasting monk fruit extract was selected. It was dissolved into water to be equivalently sweet to a 10% sucrose solution which also required a dose level of 1400 mg/L, and it was labelled S2. The S1 and S2 samples were then mixed together in different volumetric proportions. Each mixture was tested by taste judges for how well it reproduced the flavor of a 10% sucrose solution with the following results:

Doses of Two Different Sweeteners and Sugar-Like Flavor

(100:0) 1400 mg/L S1+0 mg/L S2: 55% Sugar-Like Flavor

(95:5) 1330 mg/L S1+70 mg/L S2: 65% Sugar-Like Flavor

(75:25) 1050 mg/L S1+350 mg/L S2: 60% Sugar-Like Flavor

(50:50) 700 mg/L S1+700 mg/L S2: 50% Sugar-Like Flavor

(0:100) o mg/L S1+1400 mg/L S2: 45% Sugar-Like Flavor

Based on these results, the optimum mixing ratio of S1:S2 was 95:5. When S1 and S2 were mixed, the overall solution was noticeably sweeter than before, suggesting that a synergy was discovered between the two high-potency sweeteners. The additional sweetness also meant that the 1400 mg/L dose level of Si +S2 needed to be decreased slightly to make it equivalent in sweetness to the 10% sucrose solution. A slight reduction to 1300 mg/L of S1+S2 was sufficient to recalibrate the sweetness. As discussed earlier, synergies in overall sweetness occurred during each step of the optimization, necessitating a dose level reduction of the high-potency sweetener composition.

These results also show S1 elicits a more sugar-like flavor than S2 (55% versus 45%), which explains why the optimal mixture contains more S1 than S2. The 95:5 S1:S2 mixing ratio achieved a sugar-like flavor of 65%, representing about a 10% improvement in flavor of above the 55% sugar-like flavor of the pure S1. The 75:25 S1:S2 mixing ratio also achieved a favorable sugar-like flavor of 60%, though it suffered from increasing off-flavors of S2 that taste earthy and molasses-like. In the 95:5 S1:S2 ratio, the dose level of S2 is only 70 mg/L which corresponds to 70 parts per million. Such a low dose of S2 suggests that it is acts as a potent flavor-enhancer for the more predominant S1.

The improvements in flavor can be better understood by examining the four criteria of sugar-like flavor assessed by taste judges. As described above in the section titled Methods to Judge Sugar-Like Flavor, these criteria utilize 10% sucrose, 20% sucrose, and hot and cold-brewed coffee to assess them and are assigned as follows:

### Four Criteria of Sugar-Like Flavor

(100:0) 1400 mg/L Sweetener S1
65% (TAS)+55% (INT)+30% (THK)+70% (CMP)=>55% (TOT)

(0:100) 1400 mg/L Sweetener S2
40% (TAS)+40% (INT) +30% (THK)+70% (CMP)=>45% (TOT)

(95:5) 1330 mg/L S1+70 mg/L S2
75% (TAS)+70% (INT)+40% (THK)+75% (CMP)=>65% (TOT)

When dosed individually, sweeteners S1 and S2 show the most difference in taste (TAS). The taste of S1 is clean and sweet but suffers from a delayed onset of sweetness and aftertaste, and also a peculiar localization of sweetness to the front of the tongue rather than across the whole tongue. The taste of S2 suffers from earthy, molasses off-flavors but has a fast onset of sweetness, though with some lingering aftertaste. The intensity (INT) of S1 suffers from a slight underperformance to match 20% sucrose solution. The thicknesses (THK) of S1 and S2 are equally weak. The compatibilities (CMP) of S1 and S2 are equally favorable.

At a 95:5 volumetric mixing ratio, the taste (TAS) and intensity (INT) of the mixture was dramatically improved. The delayed onset of sweetness and aftertaste of S1 improved, and the localization of sweetness to the front of the tongue became less noticeable. In addition, the mixture elicited a slight caramel flavor like natural sugar. The thickness (THK) and compatibility (CMP) of the mixture improved slightly.

### C3. Mechanisms of Synergy Between High-Potency Sweeteners

The improvement in sweetness and sugar-like taste of the 95:5 mixture of S1 and S2 suggests that synergism of action exists between these two sweeteners. There are four mechanisms by which pairs of sweeteners display synergy.

The first mechanism of sweetener interaction relates to how sweetener molecules elicit sweetness by binding to sweet-taste receptors—identified as T1 receptors—located on the tongue's taste cells. T1 receptors are discussed in International Patents WO 02/064631 and WO 03/001876. Sweeteners bind to characteristic sites on the sensor portions of the T1 receptors that are located outside the taste cells and are exposed to food molecules. Sweetener molecules bind to the T1 receptor in such a way to induce the sensor portion to change its position which in turn transmits a signal to the inside of the taste cell. When the taste of sweetener molecules is enhanced by pairing them with other sweeteners or with taste-enhancers, the effect is attributed to synergy among the molecules that strengthens their binding to the surface of the taste receptors.

The second mechanism of sweetener interaction relates to how sweeteners can suffer from delayed sweetness caused by slow rates of binding to the surface of sweet-taste receptors and prolonged aftertaste caused by slow rates of unbinding from the receptors. When their delayed sweetness and prolonged aftertaste are ameliorated by pairing them with other sweeteners or with taste-enhancers, the effect is attributed to synergy among the molecules that enhances the rate of binding and unbinding at the surface of the taste receptor.

The third mechanism of sweetener interaction relates to how sweeteners can suffer from bitter taste and loss of sweetness at higher doses caused by their binding to bitter taste receptors. When their bitterness is ameliorated by pairing them with other sweeteners or with taste-enhancers, the effect is attributed to antagonism among the molecules that suppresses binding at the surface of the bitter taste receptors.

The fourth mechanism of sweetener interaction relates to how sweeteners can suffer from off-flavors or fail to reproduce the faint caramel flavor of sugar caused by their binding to the wrong olfactory receptors located in the nasal cavity. When off-flavors are ameliorated by pairing them with other sweeteners or with taste-enhancers, the effect is attributed to antagonism among the molecules at the off-flavor olfactory receptors and synergism among the molecules at the caramel-flavor olfactory receptors.

Based on these four mechanisms of sweetener action, synergism, and antagonism, the embodiments of this invention often include one or two high-potency sweeteners.

### D. The Carbohydrate Composition

Carbohydrate compositions are an optional part of the preferred embodiments of the invention. Carbohydrate compositions are included in sweetener compositions to enhance the flavor with often negligible calories. In packaged sweetener compositions, carbohydrate compositions improve flavor and increase bulk to make dispensing more convenient. In baking applications, carbohydrate compositions are added in greater quantities to improve the texture of baked goods. In syrups and fruit preserves, carbohydrate compositions are also added in greater quantities to achieve greater sweetness intensity.

### D1. Methods to Select Carbohydrates

Natural sugars and sugar alcohols were screened from commercial sources as candidates for the carbohydrate composition. Refined and unrefined cane sugar, brown sugar, cane juice sugar, maple sugar, coconut sugar, glucose, fructose, and erythritol were dissolved into one liter of water to a strength of 10% sucrose and evaluated for flavor. Brown sugar, cane juice sugar, maple sugar, and coconut sugar were determined to have strong flavors that were not desired for the sweetener composition but seemed relevant for an embodiment of the invention that offered specialty sugar flavors. Erythritol was determined to have a drying sensation on the tongue or cooling sensation on the throat that was not desired. Fructose was determined to lose its sweetness at higher temperatures which was not desired. Glucose was determined to elicit an enhancement in the perceive thickness of flavor, so it was taken forward.

Both refined and unrefined cane sugar solutions were mixed with solutions containing the sweetener composition mixed to a strength of 10% sucrose. The unrefined cane sugar provided a stronger enhancement of sweetness, so it was taken forward.

### D2. Methods to Optimize the Carbohydrate Composition

In this example of the method, two sugars were selected for the carbohydrate composition. Unrefined cane sugar was selected as the first sugar for dose-level optimization. It was dissolved into water (100 g/L) to be identical to a 10% sucrose solution and was labelled C1.

The optimized high-potency sweetener composition (1200 mg/L HPS) and optimized electrolyte composition (240 mg/L E) were dissolved into water to achieve an equivalent sweetness as 10% sucrose (1440 mg/L total E+HPS). The sample was labelled EHPS. The C1 and EHPS samples were then mixed together in different volumetric proportions to achieve sweetening ratios from 100% EHPS sweetening (100:0) to 100% carbohydrate sweetening (0:100). Each mixture was evaluated by taste judges for how well it reproduced the flavor of a 10% sucrose solution with the following results:

EHPS plus Carbohydrate Compositions and Sugar-Like Flavor

(100:0) 1440 mg/L EHPS+0 g/L C1: 80% Sugar-Like Flavor

(97:3) 1400 mg/L EHPS+3 g/L C1: 90% Sugar-Like Flavor

(90:10) 1300 mg/L EHPS+10 g/L C1: 95% Sugar-Like Flavor

(70:30) 1000 mg/L EHPS+30 g/L C1: 97% Sugar-Like Flavor

(0:100) 0 mg/L EHPS+100 g/L C1: 100% Sugar-Like Flavor

These results reveal important synergistic interactions between the carbohydrate and the electrolyte-enhanced sweetener. The 97:3 mixture has a 90% sugar-like flavor which is exactly half-way between the sugar-like tastes of pure EHPS sweetening (100:0) (80% sugar-like flavor) and pure carbohydrate sweetening (0:100) (100% sugar-like flavor). The 97:3 mixture only contains 3% of the actual sugar and calories of the 100 g/L of sucrose in the 10% sucrose solution, and yet it tastes like what one would expect for a 50:50 mixture in the absence of a synergistic interaction. The 97:3 mixture is ideally suited for formulating a zero-calorie sweetener because its calorie content is negligible for most practical purposes.

The next step in the optimization was to introduce the second carbohydrate while keeping the total carbohydrates constant and maintaining the sweetening ratio of EHPS:carbohydrate constant at 97:3. The 3% of the total sweetness from the carbohydrate composition will be divided between the two carbohydrates, creating a second ratio, expressed as (97:3(50:50)).

Glucose was dissolved into water (100 g/L) and was labelled C2. Both the C1 and C2 samples were then separately mixed with the EHPS sample at ratios of 97:3, to make a sample with all the carbohydrate sweetening arising from C1 (97:3(100:0)) and another sample with all the carbohydrate sweetening arising from C2 (97:3(0:100)). The ratio of sweetness arising from each carbohydrate was then varied by mixing the (97:3(100:0)) and (97:3(0:100)) samples in various ratios in order to ensure the constant dose levels of the electrolyte and high-potency sweetener compositions. The resulting carbohydrate mixtures were evaluated by taste judges for how well they reproduced the flavor of a 10% sucrose solution with the following results:

EHPS plus Carbohydrate Mixtures and Sugar-Like Flavor

(97:3(100:0)) 1400 mg/L EHPS+3000 mg/L C1+0 mg/L C2: 90% Sugar-Like Flavor

(97:3(90:¹⁰)) 1400 mg/L EHPS+2700 mg/L C1+300 mg/L C2: 93% Sugar-Like Flavor

(97:3(75:25)) 1400 mg/L EHPS+2250 mg/L C1+750 mg/L C2: 95% Sugar-Like Flavor

(97:3(50:50)) 1400 mg/L EHPS+1500 mg/L C1+1500 mg/L C2: 92% Sugar-Like Flavor

(97:3(0:100)) 1400 mg/L EHPS+0 mg/L C1+3000 mg/L C2: 85% Sugar-Like Flavor

These results reveal more synergistic interactions between the two carbohydrates with each other and with the electrolyte-enhanced sweetener. It was discovered that the (97:3(75:25)) composition increased sugar-like flavor to 95%, which is a 5% increase in sugar-like flavor compared to the single carbohydrate composition (97:3(100:0)) composition and is a 15% increase in sugar-like flavor compared to the (100:0) composition containing no carbohydrate (80% sugar-like flavor). A sugar-like flavor of 95% is presumed to be as close to the actual flavor of sugar that a sweetener can get without actually being sugar.

Even more remarkably, it was discovered that a (97:3(75:25)) composition containing 75% C1 and 25% C2 caused a significant spike in sweetness, this time more dramatic than when the high-potency sweetener composition was optimized or when the electrolyte composition was optimized. It was also discovered that the C2 component glucose elicited a lingering sweet aftertaste which is unprecedented because lingering aftertaste is a phenomenon normally associated with high-potency sweeteners.

The C2 component glucose is not normally considered to be a remarkably sweet carbohydrate because it typically has only 75% of the sweetness of the C1 component sucrose by weight. But because of synergistic interactions with the other sweetener components, a dose level of 750 mg/L glucose made the overall sweetener too sweet and caused a lingering sweet aftertaste. This is a surprising discovery because it represents less than one gram of glucose per liter. The dose of 750 mg/L can also be represented as 750 parts per million, which is a dose level more typical of high-potency sweeteners.

Consequently, the dose levels of the composition needed to be reduced to make it equivalent in sweetness to 10% sucrose and to correct the lingering aftertaste. The dose level of the high-potency sweetener was reduced quite dramatically from about 0.97*1200 mg/L, or about 1160 mg/L, to under 800 mg/L, which corresponds to a 33% reduction. The dose level of the total carbohydrate composition was also reduced quite dramatically from 3000 mg/L to about 2250 mg/L, which corresponds to a 25% reduction. Once again, this was the third time that the dose levels of the sweeteners needed to be reduced because of synergies discovered during each of the three optimization steps.

It was also discovered that the electrolyte composition needed to remain at 200 mg/L potassium and 40 mg/L sodium. When the electrolyte composition was reduced alongside the other compositions, the overall composition achieved the goal of having the correct sweetness, but it caused a reduction in the thickness (THK) and it exacerbated the lingering sweet aftertaste. When the electrolyte composition was maintained at its original level, then the thickness (THK) was restored and the lingering sweet aftertaste was eliminated. The importance of this potassium and sodium dose level effect for the electrolyte composition was consistent with a hypothesis that these electrolytes were having an important synergistic effect with both the high-potency composition and the carbohydrate composition by supporting the electrophysiology of the taste cell.

The improvements in flavor can be better understood by examining the four criteria of sugar-like flavor assessed by taste judges. As described above in the section titled Methods to Judge Sugar-Like Flavor, these criteria utilize 10% sucrose, 20% sucrose, and hot and cold-brewed coffee to assess them and are assigned as follows:

### Four Criteria of Sugar-Like Flavor

(100:0) 1440 mg/L EHPS+0 mg/L C1+0 mg/L C2:
85% (TAS)+80% (INT)+80% (THK)+75% (CMP)=>8o% (TOT)

(97:3(100:0)) 1400 mg/L EHPS+3000 mg/L C1+0 mg/L C2:
90% (TAS)+90% (INT)+85% (THK)+95% (CMP)=>90% (TOT)

(97:3(75:²⁵)) 1400 mg/L EHPS+2250 mg/L C1+750 mg/L C2:
95% (TAS)+95% (INT)+95% (THK)+95% (CMP)=>95% (TOT)

(0:100(100:0)) 0 mg/L EHPS+100,000 mg/L C1+0 mg/L C2:
100% (TAS)+l00% (INT)+100% (THK)+l00% (CMP)=>100% (TOT)

In the (97:3(100:0)) mixture above, the carbohydrate composition contained only C1 and enhanced every component of sugar-like flavor but had the most impact on increasing the intensity (INT) and compatibility (CMP). The C1 component sucrose is generally recognized for its ability generate intense sweetness, so it is reassuring that even in a small dose of 3% that it can increase the ability of the sweetener composition to match the intensity (INT) of 20% sucrose solution.

Sucrose is also recognized by those skilled in the art for its ability to maintain sweetness across all temperatures, from ice-cold beverages to piping hot beverages. Other sweeteners, such as rebaudioside A and fructose, can meet or exceed the sweetness of sucrose at cold temperatures but fail to match its sweetness at higher temperatures which causes such sweeteners to have lower compatibility (CMP) scores. By including sucrose as the C1 component of the carbohydrate composition, the sweetness becomes less sensitive to temperature and the compatibility (CMP) of the overall sweetener composition improves. It is an unexpected discovery that a dose of sucrose as small 3000 mg/L can increase the sweetener composition's compatibility (CMP) sufficiently to maintain sweetness in both cold-brew coffee and hot tea.

In the (97:3(75:25)) mixture above, the carbohydrate composition contained 75% C1 and 25% C2 and yet managed to enhance three of the components of sugar-like flavor above the levels of a pure C1 carbohydrate composition and not lose ground on any of the criteria. The C2 component glucose appeared to enhance the score for the criteria of thickness (THK) the most likely because it is half the size and molecular weight of the C1 component sucrose, enabling it to have twice the contribution to osmotic pressure per unit of weight, and likely enabling it to have a disproportionate impact on perceived thickness (THK). The addition of the C2 component glucose, even at a very small dose of 750 mg/L was enough to give the sweetener composition nearly perfect scores across all four criteria of sugar-like flavor.

The dose level of the carbohydrate composition contributes negligible calories to the sweetener, especially after the 25% reduction in dose level discussed above. The initial (97:3(75:25)) composition had a dose level of 3% of the normal 100 g/L dose of sugar, which corresponded to 3 g/L of sugar which was a very small dose level. When the carbohydrate dose level was adjusted downward to 2.25 g/L to better match the sweetness of 10% sucrose, the carbohydrate dose was then equivalent to about half a teaspoonful of sugar per liter of beverage. The reduced dose of carbohydrates in the sweetener composition contributes one-half a gram of sugar and about two calories per eight-ounce serving.

### D3. Alternative Methods to Optimize the Carbohydrate Composition

In another example of the method, a carbohydrate composition is selected to comprise at least one ingredient that elicits off-flavor notes associated with sweetness. This alternative method takes advantage of the discovery that in the right dose, off-flavor notes associated with sweetness act as sweetness enhancers and contribute to the sugar-like flavor synergy of the electrolyte-enhanced sweetener composition.

This method was developed based on the discovery that unrefined cane sugar is dramatically more effective than refined white sugar at eliciting a sugar-like flavor synergy in the electrolyte-enhanced sweetener composition. Though both forms of sugar are sweet, unrefined cane sugar elicits strong flavor notes of molasses. At low doses, unrefined cane sugar helps recreate the faint molasses flavor notes of full-strength refined white sugar.

Dried cane juice also elicits flavor notes of molasses, but its molasses-flavor is so strong that it works best as a secondary component of the carbohydrate composition. It pairs well with most other carbohydrates to recreate—at low doses—the complex flavor profile of regular sugar at full-strength. Less dried cane juice is needed in the carbohydrate composition when the main component of the carbohydrate composition is an unrefined sugar, such as cane sugar, turbinado sugar, coconut sugar, palm sugar, brown sugar, maple sugar, maple syrup, and honey. More dried cane juice is needed in the carbohydrate composition when the main component of the carbohydrate composition is a highly-refined sugar or sugar alcohol such as refined white sugar, erythritol, xylitol, corn syrup, and agave syrup.

An important consequence of this method is that the carbohydrate composition becomes the source of the complex off-flavor profile, and the high-potency sweetener composition can be streamlined to only deliver sweetness potency. Consequently, there is less of a need to include multiple high-potency sweeteners in the composition. The high-potency sweetener composition can then comprise single ingredients, such as stevia leaf extract, monk fruit extract, and other artificial sweeteners. The high-potency sweetener composition could include a second or third high-potency sweetener if there was a compelling reason to adjust any unresolved effects related to potency, temperature, or slow sweetness onset and offset.

Another important consequence of this method is that a flavor synergy is observed at specific ratios of unrefined cane sugar and dried cane juice which reduces the need to include glucose in the carbohydrate composition. When the relative quantities of unrefined cane sugar and dried cane juice were optimized, the ideal ratio by dry weight was identified to exist somewhere in a range between 1:1 to 4:1 of unrefined cane sugar to dried cane juice. Upon further testing, the ideal ratio was narrowed to within a range between 2:1 to 3:1. And upon further testing, the ideal ratio by dry weight of unrefined cane sugar to dried cane juice was selected around 2.5:1 or 5:2.

When the main component of the carbohydrate composition is a highly refined sweetener, such as refined white cane sugar or erythritol, then the dry weight ratio of the highly refined sweetener to dried cane juice can be adjust downward from around 2:1 down to 1:1 in order to elicit sufficiently complex sugar-like flavor profile in the electrolyte-enhanced sweetener composition.

It is also observed that the flavors provided by dried cane juice can be extracted during the processing of sugar as molasses, or more generally, as a wet or dry cane sugar extract. The cane sugar extract can then be used as a natural flavor ingredient alongside cane sugar in the carbohydrate composition. It can be appreciated by those skilled in the art that a carbohydrate composition of cane sugar and cane sugar extract could be adjusted to become equivalent in flavor to a carbohydrate composition of unrefined cane sugar and dried cane juice.

### EXAMPLES

The present invention is further illustrated by the following example compositions and methods, which are not to be construed in any way as to be imposing limitations on the invention. On the contrary, the following examples should allow those skilled in the art to derive other embodiments from modifications and combinations of these examples without departing from the spirit of the present invention and the scope of the appended claims.
1. A method to prepare an electrolyte-enhanced sweetener composition comprising the adding together of dietary electrolyte salt, high-potency sweetener, and carbohydrate.
2. The method of example 1, wherein the dietary electrolyte salt is selected from salts in common dietary use that provide dietary potassium, dietary sodium, and dietary chloride. Potassium chloride and sodium chloride are commonly selected though other dietary salts containing dietary potassium, sodium, and chloride can be selected.
3. The method of example 1, wherein the high-potency sweetener is selected from herbal extract sweeteners and artificial sweeteners in common use to enhance the perception of potent sweetness in foods and beverages sweetened by the sweetener composition.
4. The method of example 1, wherein the dry weight ratio of high-potency sweetener to dietary electrolyte salt is selected to elicit an optimum balance of sweetness potency and flavor thickness based on the following considerations:
(a) When the dry weight ratio of high-potency sweetener to dietary electrolyte salt significantly under-represents dietary electrolyte salt, the sweetener composition will taste thinner and more artificial compared to natural sugar.
(b) When the dry weight ratio of high-potency sweetener to dietary electrolyte salt significantly over-represents dietary electrolyte salt, the sweetener composition will taste thicker like natural sugar but will also taste more salty, sour, bitter, chalky, or soapy. Such flavor profiles are commonly associated with electrolyte-rich mineral waters and sports drinks.
5. The method of example 4, wherein the high-potency sweetener is selected from high purity rebaudioside A extracts (>95% purity) from stevia leaf, high purity mogroside V extracts (>80% purity) from monk fruit, or high potency artificial sweeteners (>200× more potent than sugar). Under these circumstances, the weight ratio of high-potency sweetener to dietary electrolyte salt is selected from values around 1:2.
6. The method of example 4, wherein the high-potency sweetener is selected from moderate purity steviol glycoside extracts (>75% purity) from stevia leaf, moderate purity mogroside extracts (>50% purity) from monk fruit, or moderate potency artificial sweeteners (50× to 200× more potent than sugar). Under these circumstances, the weight ratio of high-potency sweetener to dietary electrolyte salt is selected from values around 1:1.
7. The method of example 4, wherein the high-potency sweetener is selected from partially purified steviol glycoside extracts (>50% purity) from stevia leaf, partially purified mogroside extracts (>20% purity) from monk fruit, or marginal potency artificial sweeteners (lox to 50× more potent than sugar). Under these circumstances, the weight ratio of high-potency sweetener to dietary electrolyte salt is selected from values around 2:1.
8. The method of example 1, wherein the carbohydrate is selected to comprise low-potency sweeteners in common use such as sugars, sugar alcohols, and syrups to enhance the intensity of sweetness in foods and beverages sweetened by the sweetener composition.
9. The method of example 8, wherein the carbohydrate is selected to elicit a desired flavor profile in the sweetener. Unrefined cane sugar is selected to provide a flavor profile with molasses flavor notes. Coconut sugar provides caramel flavor notes. Maple sugar provides maple flavor notes.
10. The method of example 8, wherein the carbohydrate further comprises added flavorings to elicit a desired flavor profile in the sweetener above and beyond the flavors provided by the carbohydrate in isolation. Flavoring extracts of cane juice, coconut water, and maple sap provide molasses, caramel, and maple flavor notes to the flavor profile of the sweetener.
11. The method of example 1, wherein the dry weight ratio of carbohydrate to dietary electrolyte is selected to elicit an optimum balance between sweetness intensity and flavor thickness that most closely reproduces the flavor of natural sugar.
(a) When the dry weight ratio of carbohydrate to dietary electrolyte salt significantly under-represents dietary electrolyte salt, the sweetener composition will taste thinner and more artificial compared to natural sugar.
(b) When the dry weight ratio of carbohydrate to dietary electrolyte salt significantly over-represents dietary electrolyte salt, the sweetener composition will taste thicker like natural sugar but will also taste more salty, sour, bitter, chalky, or soapy. Such flavor profiles are commonly associated with electrolyte-rich mineral waters and sports drinks.
12. The method of example 11, wherein: the carbohydrate is cane sugar and cane sugar extract; the weight ratio of carbohydrate to dietary electrolyte salt is selected from values around five to one; and the target sweetener is a tabletop granular sweetener.
13. The method of example 11, wherein: the carbohydrate is brown sugar, coconut sugar, maple sugar, cane sugar, cane sugar extract, and xanthan gum; the weight ratio of carbohydrate to dietary electrolyte salt is selected from values around fifty to one; and the target sweetener is a tabletop syrup.
14. A finely ground electrolyte-enhanced tabletop sweetener composition comprises cane sugar, dried cane juice, stevia leaf extract, potassium chloride, and sodium chloride. A one-eighth teaspoon serving of the composition provides the same sweetness as two teaspoons of sugar containing 32 calories yet contains less than one calorie and provides about 16 milligrams of dietary potassium (0% daily value) and about 3 milligrams of dietary sodium (0% daily value). The composition reproduces the flavor of natural sugar while reducing the added sugar and calories by 97%.
15. An electrolyte-enhanced tabletop syrup composition comprises water, brown sugar, coconut sugar, maple syrup, cane sugar, dried cane juice, xanthan gum, vanilla extract, stevia leaf extract, potassium chloride, sodium chloride, and potassium sorbate. A one-quarter cup serving of the electrolyte-enhanced tabletop syrup composition provides the same sweetness and flavor as a one-quarter cup serving of regular tabletop syrup yet contains about 12 grams of added sugar instead of 60 grams of added sugar and about 48 calories instead of 240 calories, representing an 80% reduction in added sugar and calories. Each serving contains sufficiently reduced sugar and calorie content that it qualifies for a “Reduced sugar” as well as a “Naturally Sweetened” marketing claim on the label. Each serving also contains an additional 105 milligrams or 3% daily value of dietary potassium and 20 milligrams or 0% daily value of dietary sodium arising from the electrolyte-enhanced sweetener.
16. An electrolyte-enhanced, sweetened beverage composition that tastes nearly indistinguishable from a sugar-sweetened beverage yet contains 97% less added sugar. Each 12-fluid-ounce or 355-milliliter serving contains about 1 additional gram of sugar and 4 additional calories arising from the electrolyte-enhanced sweetener while an equivalent serving of a sugar-sweetened beverage contains about 36 additional grams of sugar and 140 additional calories. Each serving contains sufficiently reduced sugar and calorie content that it qualifies for a “Calorie Free”, “Reduced sugar”, as well as a “Naturally Sweetened” marketing claim on the label. Each serving also contains an additional 85 milligrams or 2% daily value of dietary potassium and 15 milligrams or 0% daily value of dietary sodium arising from the electrolyte-enhanced sweetener.
17. An electrolyte-enhanced, sweetened yogurt composition that tastes nearly indistinguishable from a sugar-sweetened yogurt composition yet contains 97% less added sugar. Each 8-fluid-ounce or 240-milliliter serving contains less than one additional gram of sugar and about 3 additional calories arising from the electrolyte-enhanced sweetener while an equivalent serving of a sugar-sweetened yogurt contains about 25 additional grams of sugar and 100 additional calories. Each serving contains sufficiently reduced sugar and calorie content that it qualifies for a “Reduced sugar” as well as a “Naturally Sweetened” marketing claim on the label. Each serving also contains an additional 60 milligrams or 1% daily value of dietary potassium and 10 milligrams or 0% daily value of dietary sodium arising from the electrolyte-enhanced sweetener.
18. An electrolyte-enhanced, sweetened, fruit-flavored, powdered beverage composition that mixes into water and tastes nearly indistinguishable from a sugar-sweetened powdered beverage composition mixed with water yet contains 97% less added sugar. The powdered beverage composition comprises cane sugar, cane sugar extract, inulin, stevia leaf extract, citric acid, vitamin C, potassium chloride, sodium chloride, natural flavors, and natural colors. Each three-gram serving will flavor io-fluid-ounces or 300 milliliters of water. Each three-gram serving contains less than one additional gram of sugar and about 3 additional calories arising from the electrolyte-enhanced sweetener while an equivalent serving of a sugar-sweetened powdered beverage composition contains about 25 additional grams of sugar and 100 additional calories. Each serving contains sufficiently reduced sugar and calorie content that it qualifies for a “Reduced sugar” as well as a “Naturally Sweetened” marketing claim on the label. Each serving also contains an additional 115 milligrams or 3% daily value of dietary potassium and 20 milligrams or 0% daily value of dietary sodium arising from the electrolyte-enhanced sweetener.

While the invention has been described in detail with respect to specific embodiments thereof, it will be appreciated that those skilled in the art, upon attaining an understanding of the foregoing, may readily conceive of alterations to, variations of, and equivalents to these embodiments. Accordingly, the scope of the present invention should be assessed as that of the appended claims and any equivalents thereof.

1.-20. (canceled)

21. An electrolyte-enhanced sweetener composition comprising:
a high-potency sweetener;
sodium; and
potassium,
wherein a ratio of the potassium to the sodium is 3:1 or greater.

22. The electrolyte-enhanced sweetener composition of claim 21, wherein the high-potency sweetener is selected from the group consisting of: stevia leaf extract, stevioside, rebaudioside A, rebaudioside B, rebaudioside C, rebaudioside D, rebaudioside E, rebaudioside F, dulcoside A, monk fruit (Luo Han Guo) extract, mogroside IV, mogroside V, esgoside, siamenoside, neomogroside, sucralose, acesulfame potassium, aspartame, neotame, alitame, advantame, saccharin, and cyclamate.

23. The electrolyte-enhanced sweetener composition of claim 22, wherein the high-potency sweetener comprises the stevia leaf extract and the monk fruit (Luo Han Guo) extract.

24. The electrolyte-enhanced sweetener composition of claim 21, wherein:
an amount of the high-potency sweeter is between about 8 mg to about 14 mg per gram of sugar substituted,
an amount of the sodium is between about 0.2 mg to about 1.5 mg per gram of sugar substituted, and
an amount of the potassium is between about 1 mg to about 8 mg per gram of sugar substituted.

25. The electrolyte-enhanced sweetener composition of claim 24, wherein:
the amount of the sodium is about 0.4 mg per gram of sugar substituted, and the amount of the potassium is about 2 mg per gram of sugar substituted.

26. The electrolyte-enhanced sweetener composition of claim 24, wherein the ratio of the potassium to the sodium is in a range from about 3:1 to about 5:1.

27. The electrolyte-enhanced sweetener composition of claim 21, further comprising a carbohydrate.

28. The electrolyte-enhanced sweetener composition of claim 27, wherein the carbohydrate is selected from the group consisting of: sucrose, glucose, fructose, maltodextrin, sugar, dried cane juice, cane juice extract, brown sugar, coconut sugar, palm sugar, sugar alcohol, erythritol, mannitol, xylitol, inulin, oligosaccharide, polysaccharide, xanthan gum, gum base, cellulose, glycerol, unrefined sweetener, honey, corn syrup, maple syrup, rice syrup, agave syrup, dried fruit, fruit juice, and fruit juice concentrate.

29. The electrolyte-enhanced sweetener composition of claim 27, wherein:
an amount of the carbohydrate is between about 30 mg to about 300 mg per gram of sugar substituted.

30. An electrolyte-enhanced sweetener composition comprising:
a high-potency sweetener selected from the group consisting of: a stevia leaf extract and a monk fruit (Luo Han Guo) extract;
sodium;
potassium; and
a carbohydrate,
wherein a ratio of the potassium to the sodium in 3:1 or greater.

31. The electrolyte-enhanced sweetener composition of claim 30, wherein the ratio of the potassium to the sodium is in a range from about 3:1 to about 5:1.

32. The electrolyte-enhanced sweetener composition of claim 30, wherein the carbohydrate is selected from the group consisting of: sugar, sugar alcohol, syrup, polysaccharide, and gum base.

33. The electrolyte-enhanced sweetener composition of claim 30, wherein the electrolyte-enhanced sweetener composition is a packaged sweetener product in a form of a solid, a liquid, a syrup, a gel, an aerosol, a powder, or granules.

34. The electrolyte-enhanced sweetener composition of claim 33, wherein the packaged sweetener product is in the form of the solid, and wherein the solid is selected from the group consisting of: pressed cubes, tablets, and pellets.

35. The electrolyte-enhanced sweetener composition of claim 30, wherein the potassium comprises potassium chloride, and wherein the sodium comprises sodium chloride.

36. The electrolyte-enhanced sweetener composition of claim 35, wherein the electrolyte-enhanced sweetener composition comprises:
an amount of the high-potency sweetener between about 40 mg/8 g to about 300 mg/8 g sugar substituted,
an amount of potassium chloride between about 20 mg/8 g to about 400 mg/8 g sugar substituted,
an amount of sodium chloride between about 8 mg/8 g to about 200 mg/8 g sugar substituted, and
an amount of the carbohydrate between about 500 mg/8 g to about 4 g/8 g sugar substituted.

37. The electrolyte-enhanced sweetener composition of claim 30, wherein the electrolyte-enhanced sweetener composition is incorporated into a product selected from the group consisting of: a beverage and a concentrate.
